(19) United States
(12) Patent Application Publication
(10) Pub. No.: US 2026/0226984 A1
(43) Pub. Date: Aug. 6, 2026

(54) MECHANICAL SEAL

(71) Applicant: PILLAR CORPORATION, Osaka (JP)

(72) Inventors: Koki Fukui, Osaka (JP); Yuki Tomida, Osaka (JP)

(73) Assignee: PILLAR CORPORATION, Osaka (JP)

(21) Appl. No.: 19/147,414

(22) PCT Filed: Jan. 25, 2024
(86) PCT No.: PCT/JP2024/002149

§ 371 Date: Jul. 11, 2025

(30) Foreign Application Priority Data
Mar. 16, 2023 (JP) 2023-042146

(51) Int. Cl. F16J 15/34

(52) U.S. Cl. CPC F16J 15/3404; F16J 15/3492

(57) ABSTRACT

A mechanical seal including a rotary side unit provided on a rotary shaft of a rotary machine so as to be rotatable therewith and having a rotary sealing ring, and a stationary side unit provided on a casing, of the rotary machine, surrounding the rotary shaft, the stationary side unit having a stationary sealing ring on which the rotary sealing ring slides, sliding portions of the rotary sealing ring and the stationary sealing ring being cooled by a flushing fluid, includes: a first temperature detection part provided in the stationary side unit and configured to detect a first temperature of the flushing fluid before cooling the sliding portions; and a second temperature detection part provided separately from the first temperature detection part in the stationary side unit and configured to detect a second temperature of the flushing fluid after cooling the sliding portions.

### TECHNICAL FIELD

The present invention relates to a mechanical seal.

### BACKGROUND ART

As a seal for sealing a sealing target fluid inside a rotary machine, for example, a mechanical seal described in PATENT LITERATURE 1 is known. The mechanical seal of PATENT LITERATURE 1 includes a rotary sealing ring (rotary ring) provided on a rotary shaft of a rotary machine so as to slide on a stationary sealing ring, and the stationary sealing ring (fixed ring) provided on a housing of the rotary machine. The sliding portions of the rotary sealing ring and the stationary sealing ring are cooled and lubricated by a flushing fluid.

### CITATION LIST

### Patent Literature

PATENT LITERATURE 1: Japanese Laid-Open Patent Publication No. 2021-060079

### SUMMARY OF THE INVENTION

### Technical Problem

In the mechanical seal of PATENT LITERATURE 1, in order to grasp whether or not the sliding portions of the rotary sealing ring and the stationary sealing ring are appropriately cooled by the flushing fluid, it is necessary to disassemble the mechanical seal and visually and directly observe the sliding portions. Therefore, it is difficult to grasp the cooling state of the sliding portions while the mechanical seal is in operation.

Therefore, the applicant of this application has proposed a mechanical seal including a temperature difference detection part that detects the temperature difference between the temperature of a flushing fluid before cooling the sliding portions and the temperature of the flushing fluid after cooling the sliding portions (International Application PCT/JP2022/042538; hereinafter referred to as earlier application invention). With this earlier application invention, it is possible to grasp the cooling state of the sliding portions, based on the temperature difference detected by the temperature difference detection part, but there is a desire to grasp the cooling state of the sliding portions more accurately.

The present disclosure has been made in view of such circumstances, and an object of the present disclosure is to provide a mechanical seal that allows a cooling state of a flushing fluid at sliding portions of a rotary sealing ring and a stationary sealing ring to be grasped more accurately.

### Solution to Problem

(1) The present disclosure is directed to a mechanical seal including a rotary side unit provided on a rotary shaft of a rotary machine so as to be rotatable therewith and having a rotary sealing ring, and a stationary side unit provided on a casing, of the rotary machine, surrounding the rotary shaft, the stationary side unit having a stationary sealing ring on which the rotary sealing ring slides, sliding portions of the rotary sealing ring and the stationary sealing ring being cooled by a flushing fluid, the mechanical seal including: a first temperature detection part provided in the stationary side unit and configured to detect a first temperature of the flushing fluid before cooling the sliding portions; and a second temperature detection part provided separately from the first temperature detection part in the stationary side unit and configured to detect a second temperature of the flushing fluid after cooling the sliding portions.

In the mechanical seal of the present disclosure, since the first temperature detection part and the second temperature detection part are separate from each other, the first temperature detection part can be provided at a position where the first temperature of the flushing fluid before cooling can be accurately detected, and the second temperature detection part can be provided at a position where the second temperature of the flushing fluid after cooling can be accurately detected. Accordingly, an accurate temperature difference between the first temperature and the second temperature can be calculated, so that it is possible to accurately grasp the cooling state of the flushing fluid at the sliding portions of the rotary sealing ring and the stationary sealing ring.

(2) In the mechanical seal of (1) above, preferably, the stationary side unit further has a tubular seal case for partitioning an inside region and an outside region of the rotary machine, a first flow passage formed at a predetermined location in a circumferential direction in the seal case and configured to supply the flushing fluid before cooling the sliding portions, to the inside region, and an adapter ring provided on the seal case in the inside region and having a second flow passage formed therein for supplying the flushing fluid from the first flow passage toward a plurality of locations in the circumferential direction of the sliding portions, the adapter ring has a mounting hole into which the second temperature detection part is inserted from a radially outer side toward a radially inner side of the adapter ring, and a tapered inner circumferential surface is formed at an opening end portion on the radially outer side of the mounting hole such that a hole diameter of the mounting hole gradually increases from the radially inner side toward the radially outer side.

In this case, the second temperature detection part is guided to the radially inner side of the mounting hole by the tapered inner circumferential surface, which is formed at the opening end portion of the mounting hole, when the second temperature detection part is inserted into the mounting hole from the radially outer side of the adapter ring. Accordingly, the second temperature detection part can be mounted at an appropriate position with respect to the adapter ring, so that the second temperature detection part can more accurately detect the second temperature. As a result, the cooling state of the flushing fluid at the sliding portions can be more accurately grasped.

(3) In the mechanical seal of (2) above, preferably, the adapter ring further has an inflow passage arranged on the radially outer side with respect to the mounting hole and communicating with the mounting hole, and a pressure loss portion configured to cause pressure loss in the flushing fluid flowing into the inflow passage from the radially outer side of the inflow passage.

In this case, since the pressure loss portion causes pressure loss in the flushing fluid flowing into the inflow passage, it becomes difficult for the flushing fluid to flow into the inflow passage. Accordingly, the flushing fluid before cooling can be inhibited from passing between the mounting hole and the second temperature detection part from the inflow passage and mixing with the flushing fluid after cooling within the inside region. As a result, the second temperature detection part can more accurately detect the second temperature. In addition, a seal member (a rubber stopper or the like) that inhibits the flushing fluid before cooling from passing between the mounting hole and the second temperature detection part is no longer required. Accordingly, troublesome work of mounting the second temperature detection part to the mounting hole with a seal member located therebetween is no longer required, so that work of mounting the second temperature detection part to the mounting hole can be easily performed.

(4) In the mechanical seal of (2) or (3) above, preferably, in a state where the second temperature detection part is inserted into the mounting hole, a temperature measurement point of the second temperature detection part is located on the inside region side with respect to the sliding portions.

In this case, the inside region side with respect to the sliding portions has a high proportion of the flushing fluid after cooling, so that the second temperature detection part can more accurately detect the second temperature. Accordingly, the cooling state of the flushing fluid at the sliding portions can be more accurately grasped.

(5) In the mechanical seal of any one of (2) to (4) above, preferably, a plurality of holes that can be used as the first flow passage are formed in the seal case so as to be arranged in the circumferential direction, one of the plurality of holes is the first flow passage, and at least another one of the plurality of holes is an insertion hole into which the second temperature detection part is inserted.

In this case, in the seal case, among the plurality of holes that can be used as the first flow passage, the hole that is not used as the first flow passage can be used as the insertion hole into which the second temperature detection part is inserted. Accordingly, it is not necessary to form a dedicated insertion hole in the seal case, so that work of mounting the second temperature detection part to the mounting hole can be more easily performed.

(6) In the mechanical seal of any one of (1) to (5) above, preferably, the stationary side unit further has a tubular seal case for partitioning an inside region and an outside region of the rotary machine, a first flow passage formed at a predetermined location in a circumferential direction in the seal case and configured to supply the flushing fluid before cooling the sliding portions, to the inside region, and an adapter ring provided on the seal case in the inside region and having a second flow passage formed therein for supplying the flushing fluid from the first flow passage toward a plurality of locations in the circumferential direction of the sliding portions, the second flow passage is formed on a radially outer side of the adapter ring and has an annular flow passage through which the flushing fluid flows in the circumferential direction before being supplied to the sliding portions, and a temperature measurement point of the first temperature detection part is located within the annular flow passage.

In this case, the first temperature detection part can measure the temperature of the flushing fluid that is less likely to be affected by heat transfer from the seal case compared to the case where the temperature measurement point of the first temperature detection part is located within the first flow passage in the seal case. As a result, the first temperature detection part can more accurately detect the first temperature, so that the cooling state of the flushing fluid at the sliding portions can be more accurately grasped.

(7) In the mechanical seal of (6) above, preferably, a plurality of holes that can be used as the first flow passage are formed in the seal case so as to be arranged in the circumferential direction, one of the plurality of holes is the first flow passage, and at least another one of the plurality of holes is an insertion hole into which the first temperature detection part is inserted.

In this case, in the seal case, among the plurality of holes that can be used as the first flow passage, the hole that is not used as the first flow passage can be used as the insertion hole into which the first temperature detection part is inserted. Accordingly, it is not necessary to form a dedicated insertion hole in the seal case or the casing, so that work of mounting the first temperature detection part to the insertion hole can be easily performed.

### Advantageous Effects of the Invention

With the mechanical seal of the present disclosure, it is possible to accurately grasp the cooling state of the flushing fluid at the sliding portions of the rotary sealing ring and the stationary sealing ring.

### BRIEF DESCRIPTION OF DRAWINGS

FIG. 1 is a cross-sectional view of a mechanical seal according to a first embodiment of the present disclosure.

FIG. 2 is an enlarged cross-sectional view showing an adapter ring and an area therearound on the lower side of FIG. 1.

FIG. 3 is a cross-sectional view as seen in the direction of arrows I-I in FIG. 1.

FIG. 4 is an enlarged cross-sectional view showing the adapter ring and the area therearound on the upper side of FIG. 1.

FIG. 5 is an enlarged cross-sectional view showing a mounting hole of an adapter ring and an area therearound in a mechanical seal according to a second embodiment of the present disclosure.

### DETAILED DESCRIPTION

Next, preferred embodiments of the present disclosure will be described with reference to the accompanying drawings. At least parts of the embodiments described below may be combined as desired.

### First Embodiment

### <Entire Configuration>

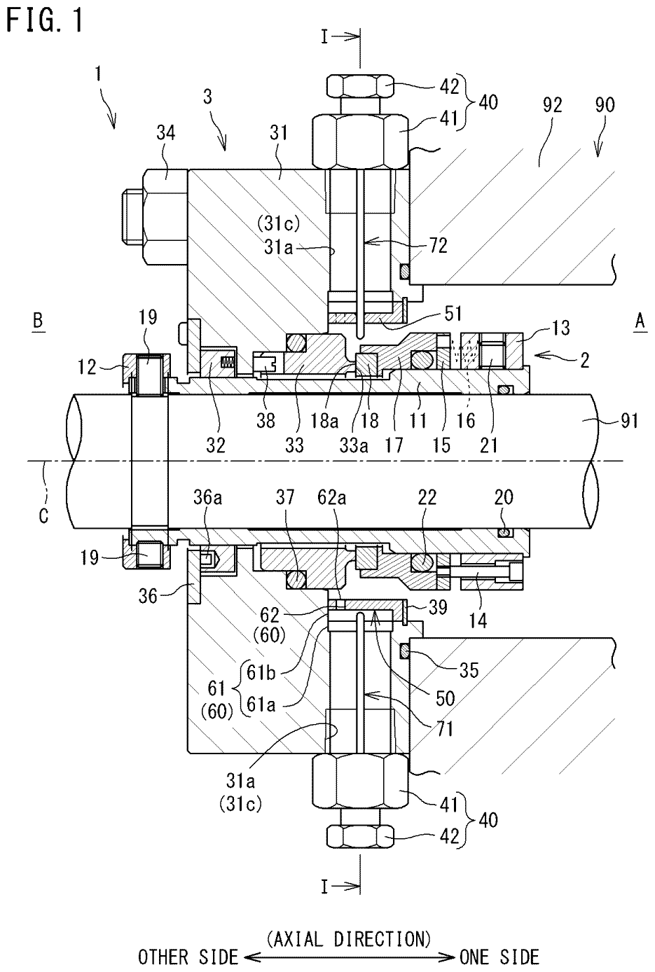

FIG. 1 is a cross-sectional view of a mechanical seal 1 according to a first embodiment of the present disclosure. In FIG. 1, the mechanical seal 1 is used in a rotary machine 90 such as a pump and seals a sealing target fluid inside the rotary machine 90. The rotary machine 90 includes a rotary shaft 91 and a casing 92 surrounding the rotary shaft 91.

The mechanical seal 1 is placed along the axial direction of the rotary shaft 91 between the rotary shaft 91 and the casing 92.

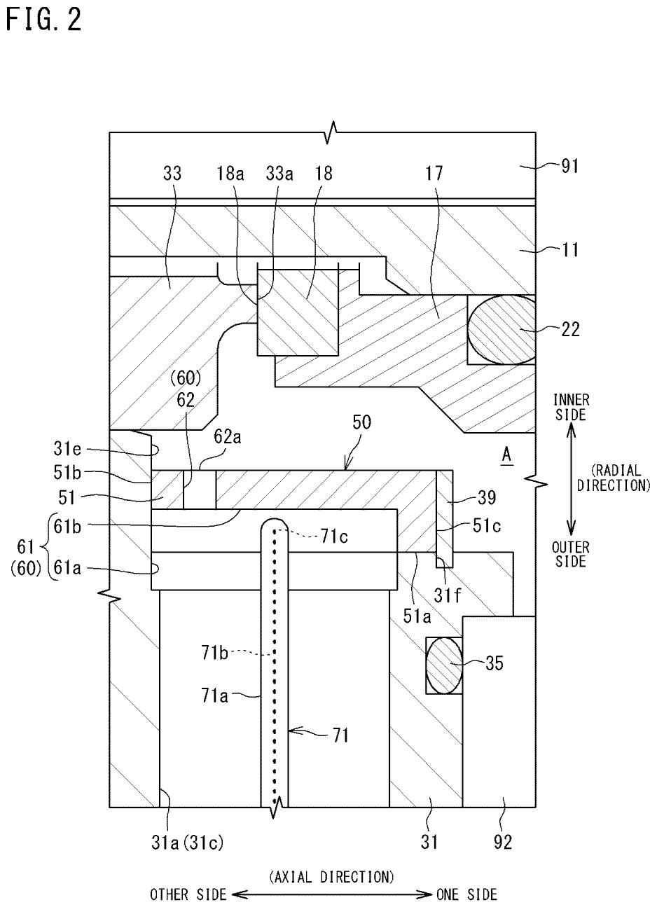

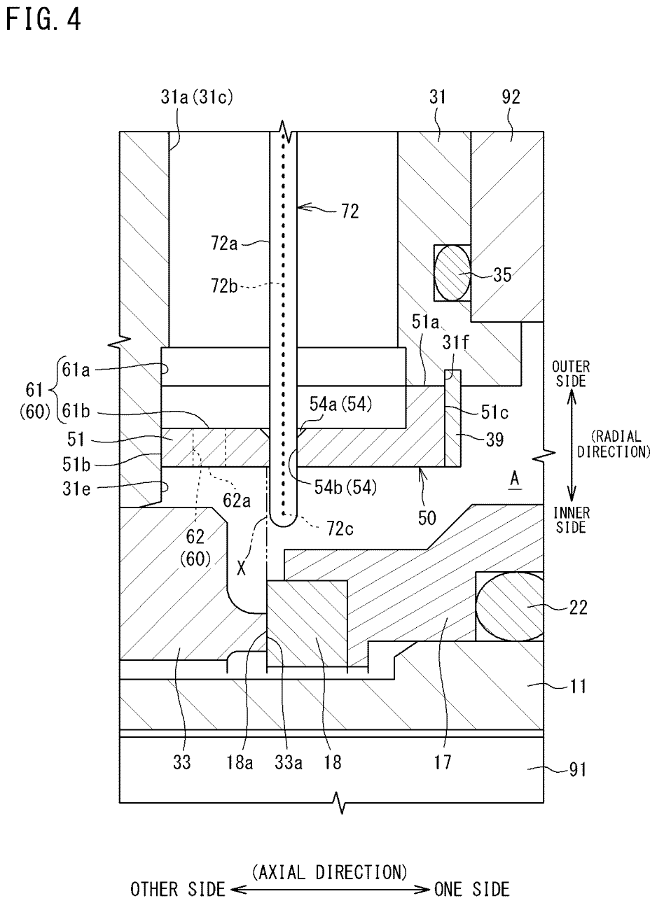

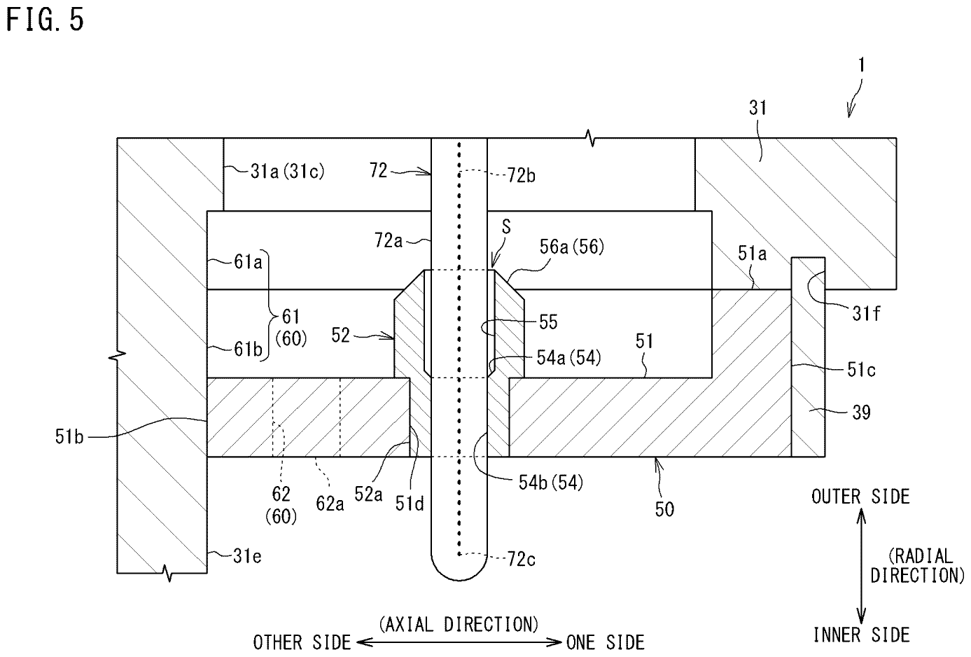

Hereinafter, in this specification, the “axial direction” is a direction along a center line C of the rotary shaft 91 (including a direction parallel to the center line C). In addition, in the present disclosure, the “radial direction” is a direction orthogonal to the center line C of the rotary shaft 91, and the “circumferential direction” is a direction around the center line C of the rotary shaft 91. In addition, in this specification, for convenience, the right side of FIG. 1 is referred to as one side in the axial direction, and the left side of FIG. 1 is referred to as another side in the axial direction (the same applies to FIG. 2, FIG. 4, and FIG. 5).

The mechanical seal 1 of the present embodiment includes a rotary side unit 2 provided on the rotary shaft 91 so as to be rotatable therewith, and a stationary side unit 3 provided on the casing 92.

### <Rotary Side Unit>

The rotary side unit 2 includes a sleeve 11, a stopper ring 12, a first retainer 13, drive pins 14, a drive collar 15, springs 16, a second retainer 17, and a rotary sealing ring 18.

The sleeve 11 is formed in a cylindrical shape and is fitted to the outer circumference of the rotary shaft 91. The stopper ring 12 is fitted to the outer circumference of the sleeve 11 on the other side in the axial direction. A plurality of set screws 19 are screwed into the stopper ring 12 in the radial direction so as to be arranged in the circumferential direction of the stopper ring 12. Accordingly, the sleeve 11 is fixed to the rotary shaft 91. An O-ring 20 seals (secondarily seals) between the inner circumferential surface of the sleeve 11 on the one side in the axial direction and the outer circumferential surface of the rotary shaft 91.

The first retainer 13 is a spring retainer. The first retainer 13 is formed in an annular shape and is fitted to the outer circumference of the sleeve 11 on the one side in the axial direction. A plurality of set screws 21 (only one is shown in FIG. 1) are screwed into the first retainer 13 in the radial direction so as to be arranged in the circumferential direction of the first retainer 13. Accordingly, the first retainer 13 is fixed to the sleeve 11. The plurality of drive pins 14 (only one is shown in FIG. 1) penetrate the first retainer 13 in the axial direction so as to be spaced apart from each other in the circumferential direction. The drive pins 14 are held so as to be movable in the axial direction with respect to the first retainer 13.

The drive collar 15 is placed on the other side in the axial direction of the first retainer 13 so as to be spaced apart therefrom. The drive collar 15 is formed in an annular shape and is fitted on the outer circumferential surface of the sleeve 11 so as to be movable in the axial direction with respect to this outer circumferential surface. An end portion on the other side in the axial direction of each drive pin 14 is fixed (screwed) to the drive collar 15. Accordingly, the drive collar 15 is held so as to be movable in the axial direction with respect to the first retainer 13 via the drive pins 14 and is restricted from rotating relative to the first retainer 13.

The plurality of springs 16 (only one is shown in FIG. 1) are provided between the drive collar 15 and the first retainer 13 so as to be spaced apart from each other in the circumferential direction. Each spring 16 biases the drive collar 15 against the first retainer 13 toward the other side in the axial direction.

The second retainer 17 is placed adjacently on the other side in the axial direction of the drive collar 15. The second retainer 17 is formed in an annular shape and is fitted on the outer circumferential surface of the sleeve 11 so as to be movable in the axial direction with respect to this outer circumferential surface. An end portion on the one side in the axial direction of the second retainer 17 is fixed to the drive collar 15. Accordingly, the second retainer 17 is restricted from rotating relative to the drive collar 15, while being held so as to be moveable in the axial direction with respect to the sleeve 11 together with the drive collar 15. An O-ring 22 seals (secondarily seals) between the inner circumferential surface of the second retainer 17 and the outer circumferential surface of the sleeve 11.

The rotary sealing ring 18 is formed in an annular shape and is fixed (shrink-fitted) to another end portion in the axial direction of the second retainer 17. A sealing surface 18a is formed on the end surface on the other side in the axial direction of the rotary sealing ring 18 (see also FIG. 2). The rotary sealing ring 18 is biased toward the other side in the axial direction via the drive collar 15 and the second retainer 17 by the springs 16.

### <Stationary Side Unit>

The stationary side unit 3 includes a seal case 31, a bushing 32, a stationary sealing ring 33, and an adapter ring 50. The seal case 31 is formed in a cylindrical shape. The seal case 31 is fixed to the casing 92 so as to surround the rotary shaft 91 in order to partition an inside region A and an outside region B of the rotary machine 90.

In the present embodiment, a radially outer portion of the seal case 31 is fixed to the casing 92 by a bolt 34 in a state of being in contact with the side surface on the other side in the axial direction of the casing 92. An O-ring 35 seals (secondarily seals) between the side surface on the one side in the axial direction of the seal case 31 and the side surface on the other side in the axial direction of the casing 92.

The bushing 32 is mounted on the inner circumference of the seal case 31 on the other side in the axial direction. The bushing 32 is formed in an annular shape and forms a clearance seal between the outer circumferential surface of the sleeve 11 and the bushing 32.

An annular restriction member 36 is fixed to the end surface on the other side in the axial direction of the seal case 31.

The end surface on the other side in the axial direction of the bushing 32 is in contact with the restriction member 36. Accordingly, the bushing 32 is restricted from being pulled out from the seal case 31 to the other side in the axial direction. The restriction member 36 has an engagement pin 36a that is engaged with the bushing 32. Accordingly, the restriction member 36 restricts the bushing 32 from rotating together with the sleeve 11.

The stationary sealing ring 33 is formed in an annular shape and is fitted and fixed to the inner circumferential surface of the seal case 31. An O-ring 37 seals (secondarily seals) between the outer circumferential surface of the stationary sealing ring 33 and the inner circumferential surface of the seal case 31. A sealing surface 33a is formed on the end surface on the one side in the axial direction of the stationary sealing ring 33 (see also FIG. 2).

The sealing surface 18a of the rotary sealing ring 18 slides on the sealing surface 33a of the stationary sealing ring 33. The stationary sealing ring 33 is restricted from rotating relative to the rotary sealing ring 18, by a restriction pin 38 fixed to the inner circumference of the seal case 31.

The adapter ring 50 is placed radially outward of sliding portions (sealing surfaces 18a and 33a) of the rotary sealing ring 18 and the stationary sealing ring 33 in the inside region A. Hereinafter, the sliding portions of the rotary sealing ring 18 and the stationary sealing ring 33 are also referred to as sliding portions 18a and 33a. The adapter ring 50 of the present embodiment is composed of a ring body 51 formed in a cylindrical shape. The ring body 51 is detachably provided on the seal case 31.

FIG. 2 is an enlarged cross-sectional view showing the adapter ring 50 and an area therearound on the lower side of FIG. 1. In FIG. 1 and FIG. 2, the one side in the axial direction of an outer circumferential surface 51a of the ring body 51 is fitted to the inner circumferential surface of the seal case 31. An end surface 51b on the other side in the axial direction of the ring body 51 is in contact with a step surface 31e extending in the radial direction on the inner circumference of the seal case 31.

An end surface 51c on the one side in the axial direction of the ring body 51 is in contact with a snap ring 39 mounted on the seal case 31. Accordingly, the ring body 51 is held between the step surface 31e and the snap ring 39, so that the ring body 51 is held such that the ring body 51 does not come out of the seal case 31.

The snap ring 39 is detachably fitted into an annular recessed groove 31f formed on the inner circumference of the seal case 31. The ring body 51 can be detached from the seal case 31 by detaching the snap ring 39 from the recessed groove 31f.

### <Flow Passage for Flushing Fluid>

A flow passage for supplying a flushing fluid from the outside region B to the inside region A is formed in the stationary side unit 3. The flushing fluid cools and lubricates the sliding portions 18a and 33a of the rotary sealing ring 18 and the stationary sealing ring 33. In the present embodiment, a sealing target fluid is used as the flushing fluid. Hereinafter, the flushing fluid before cooling the sliding portions 18a and 33a is also referred to as “flushing fluid before cooling”. In addition, the flushing fluid after cooling the sliding portions 18a and 33a is also referred to as “flushing fluid after cooling”.

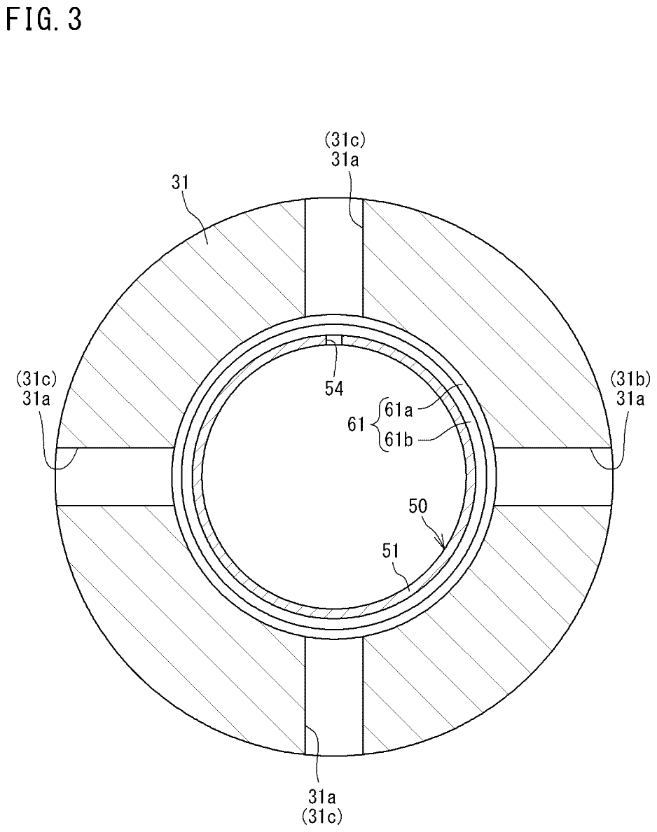

FIG. 3 is a cross-sectional view as seen in the direction of arrows I-I in FIG. 1. In FIG. 3, only the seal case 31 and the adapter ring 50 are shown. In FIG. 1 and FIG. 3, a plurality of holes 31a (four in FIG. 3) are formed on the one side in the axial direction of the seal case 31 so as to be spaced apart from each other in the circumferential direction of the seal case 31. Each hole 31a is formed so as to penetrate the seal case 31 in the radial direction. Each hole 31a can be used as a first flow passage 31b for supplying the flushing fluid before cooling from the outside region B to the inside region A.

The reason why the plurality of holes 31a each of which can be used as the first flow passage 31b are formed in the circumferential direction of the seal case 31 is that the position in the circumferential direction where a pipe through which the flushing fluid flows is connected to the seal case 31 is different depending on the type of the rotary machine 90, etc. In the present embodiment, the hole 31a formed on the right side of FIG. 3 is used as the first flow passage 31b. Therefore, the first flow passage 31b for supplying the flushing fluid before cooling from the outside region B to the inside region A is formed at a predetermined location in the circumferential direction of the seal case 31.

The other holes 31a that are not used as the first flow passage 31b are each hereinafter also referred to as spare hole 31c. The opening on the radially outer side of each spare hole 31c is blocked by a blocking member 40. The blocking member 40 has, for example, a first screw portion 41 that is screwed into the spare hole 31c and a second screw portion 42 that is screwed into the head of the first screw portion 41. The blocking member 40 inhibits the flushing fluid flowing from an annular flow passage 61 (described later) into the spare hole 31c from leaking to the outside.

The seal case 31 and the adapter ring 50 have a second flow passage 60 formed therein so as to communicate with the plurality of holes 31a (the first flow passage 31b and the spare holes 31c) of the seal case 31. The second flow passage 60 is a flow passage for supplying the flushing fluid from the first flow passage 31b toward a plurality of locations in the circumferential direction of the sliding portions 18a and 33a. The second flow passage 60 has the annular flow passage 61 and a plurality of supply flow passages 62.

The annular flow passage 61 is composed of a first annular groove 61a formed on the inner circumference of the seal case 31, and a second annular groove 61b formed on the outer circumference of the adapter ring 50. The first annular groove 61a communicates with each hole 31a of the seal case 31. The second annular groove 61b is formed at a position opposing the first annular groove 61a, on the outer circumference of the ring body 51. The groove width of the second annular groove 61b is the same as the groove width of the first annular groove 61a. The flushing fluid before cooling from the first flow passage 31b flows in the circumferential direction and circulates in the annular flow passage 61 immediately before being supplied to the sliding portions 18a and 33a.

In FIG. 1 and FIG. 2, the plurality of supply flow passages 62 are flow passages for supplying the flushing fluid before cooling from the annular flow passage 61 to the inside region A. The supply flow passages 62 are formed so as to penetrate the ring body 51 (adapter ring 50) in the radial direction from a plurality of locations in the circumferential direction on the bottom surface of the second annular groove 61b. Accordingly, the flushing fluid before cooling is supplied from the plurality of supply flow passages 62 to the inside region A, so that the sliding portions 18a and 33a can be uniformly cooled and lubricated over the entireties thereof in the circumferential direction.

Each supply flow passage 62 is formed such that an opening 62a on the radially inner side thereof is located on the other side in the axial direction (outside region B side) with respect to the sliding portions 18a and 33a. Accordingly, in the inside region A, the flushing fluid before cooling and the flushing fluid after cooling are generally separated into both sides in the axial direction, respectively, with a virtual extension line X of the sliding portions 18a and 33a as a boundary. Specifically, in the inside region A, the flushing fluid before cooling occupies the region on the other side in the axial direction with respect to the virtual extension line X, and the flushing fluid after cooling occupies the region on the one side in the axial direction with respect to the virtual extension line X. The opening 62a of each supply flow passage 62 may be located on the one side in the axial direction (outside region A side) with respect to the sliding portions 18a and 33a or may be located straddling the sliding portions 18a and 33a in the axial direction.

### <First Temperature Detection Part>

The mechanical seal 1 further includes a first temperature detection part 71 provided in the stationary side unit 3. The first temperature detection part 71 detects a first temperature of the flushing fluid before cooling. The first temperature detection part 71 is composed of, for example, a sheathed thermocouple.

The first temperature detection part 71 has a sheath 71a and a thermocouple wire 71b. The sheath 71a is composed of, for example, a long, thin metal tube member and covers the thermocouple wire 71b. The sheath 71a is inserted into an insertion hole formed in the seal case 31. In the present embodiment, the spare hole 31c on the lower side of FIG. 1 in the seal case 31 is used as the insertion hole into which the sheath 71a is inserted. A proximal end portion (lower end portion in FIG. 1) of the sheath 71a inserted into the insertion hole (spare hole) 31c is attached to the blocking member 40.

The thermocouple wire 71b has a temperature measurement point 71c at a distal end (upper end in FIG. 2) thereof. The temperature measurement point 71c is located within the annular flow passage 61 of the second flow passage 60. The temperature measurement point 71c of the present embodiment is located, for example, within the second annular groove 61b. The first temperature detection part 71 measures the temperature of the flushing fluid before cooling circulating in the annular flow passage 61, by the temperature measurement point 71c, thereby measuring the first temperature of this flushing fluid.

### <Second Temperature Detection Part>

FIG. 4 is an enlarged cross-sectional view showing the adapter ring 50 and the area therearound on the upper side of FIG. 1. In FIG. 1 and FIG. 4, the mechanical seal 1 further includes a second temperature detection part 72 provided separately from the first temperature detection part 71 in the stationary side unit 3. The second temperature detection part 72 detects a second temperature of the flushing fluid after cooling. The second temperature detection part 72 is composed of, for example, a sheathed thermocouple that is the same as the first temperature detection part 71.

The second temperature detection part 72 has a sheath 72a and a thermocouple wire 72b. The sheath 72a is composed of, for example, a long, thin metal tube member and covers the thermocouple wire 72b. The sheath 72a is inserted into an insertion hole formed in the seal case 31. In the present embodiment, the spare hole 31c on the upper side of FIG. 1 in the seal case 31 is used as the insertion hole into which the sheath 72a is inserted.

A distal end portion (lower end portion in FIG. 1) of the sheath 72a inserted into the insertion hole (spare hole) 31c is inserted into and mounted to a mounting hole 54 formed in the ring body 51. The mounting hole 54 is formed at a position corresponding to the insertion hole 31c, so as to penetrate the ring body 51 in the radial direction from the bottom surface of the second annular groove 61b (see also FIG. 3).

A tapered inner circumferential surface 54a and a fitting inner circumferential surface 54b are formed on the inner circumference of the mounting hole 54. The tapered inner circumferential surface 54a is formed at an opening end portion on the radially outer side (upper side in FIG. 4) of the mounting hole 54. The fitting inner circumferential surface 54b is formed at a portion of the mounting hole 54 other than the opening end portion. The fitting inner circumferential surface 54b has a constant inner diameter over the entire length in the radial direction (up-down direction in FIG. 4) thereof. The inner diameter of the fitting inner circumferential surface 54b is substantially the same as the outer diameter of the sheath 72a.

The inner diameter of the tapered inner circumferential surface 54a (the hole diameter of the opening end portion of the mounting hole 54) gradually increases from the radially inner side toward the radially outer side of the ring body 51. The maximum outer diameter of the tapered inner circumferential surface 54a is larger than the outer diameter of the sheath 72a. The minimum inner diameter of the tapered inner circumferential surface 54a is the same as the inner diameter of the fitting inner circumferential surface 54b. The distal end portion of the sheath 72a is inserted so as to penetrate the mounting hole 54 from the radially outer side toward the radially inner side of the ring body 51. At that time, the distal end portion of the sheath 72a is guided to the fitting inner circumferential surface 54b by the tapered inner circumferential surface 54a and fitted to the fitting inner circumferential surface 54b.

The thermocouple wire 72b has a temperature measurement point 72c at a distal end (lower end in FIG. 4) thereof. In a state where the second temperature detection part 72 is fitted to the fitting inner circumferential surface 54b of the mounting hole 54, the temperature measurement point 72c is located radially inward of the ring body 51 and is located on the one side in the axial direction (the inside region A side) with respect to the sliding portions 18a and 33a. The second temperature detection part 72 measures the temperature of the flushing fluid after cooling that is on the one side in the axial direction with respect to the sliding portions 18a and 33a in the inside region A, by the temperature measurement point 72c, thereby detecting the second temperature of this flushing fluid.

By calculating the temperature difference between the first temperature and the second temperature detected by the first temperature detection part 71 and the second temperature detection part 72, respectively, a business entity or the like who performs maintenance and inspection of the mechanical seal 1 can grasp the cooling state of the sliding portions 18a and 33a based on the temperature difference. Specifically, if the temperature difference is relatively large, the heat generation at the sliding portions 18a and 33a is increased due to frictional heat, etc., so that the business entity or the like can grasp that the current situation is a situation in which the amount of the flushing fluid supplied to the sliding portions 18a and 33a is insufficient. In addition, if the temperature difference is relatively small, the heat generation at the sliding portions 18a and 33a is reduced to be low, so that the business entity or the like can grasp that the current situation is a situation in which the sliding portions 18a and 33a are appropriately cooled and lubricated by the flushing fluid.

### <Advantageous Effects>

In the mechanical seal 1 of the present embodiment, the first temperature detection part 71 and the second temperature detection part 72 are separate from each other. Accordingly, the first temperature detection part 71 can be provided at a position where the first temperature of the flushing fluid before cooling can be accurately detected, and the second temperature detection part 72 can be provided at a position where the second temperature of the flushing fluid after cooling can be accurately detected. As a result, an accurate temperature difference between the first temperature and the second temperature can be calculated, so that it is possible to accurately grasp the cooling state of the flushing fluid at the sliding portions 18a and 33a of the rotary sealing ring 18 and the stationary sealing ring 33. Specifically, based on the temperature difference, a coefficient of kinetic friction, which is closely related to the cooling state of the sliding portions 18a and 33a, can be calculated. The calculation formula for the coefficient of kinetic friction includes the characteristics of the flushing fluid and the operating conditions of the mechanical seal 1. Therefore, the calculated coefficient of kinetic friction is a numerical value that takes into account the differences in flushing fluid and operating conditions, so that the cooling state of the sliding portions 18a and 33a can be accurately grasped if the calculated coefficient of kinetic friction is used.

The second temperature detection part 72 is guided to the fitting inner circumferential surface 54b of the mounting hole 54 by the tapered inner circumferential surface 54a, which is formed at the opening end portion of the mounting hole 54, when the second temperature detection part 72 is inserted into the mounting hole 54 from the radially outer side of the adapter ring 50. Accordingly, the second temperature detection part 72 can be mounted at an appropriate position with respect to the adapter ring 50, so that the second temperature detection part 72 can more accurately detect the second temperature. As a result, the cooling state of the flushing fluid at the sliding portions 18a and 33a can be more accurately grasped.

In a state where the second temperature detection part 72 is inserted into the mounting hole 54, the temperature measurement point 72c of the second temperature detection part 72 is located on the inside region A side (one side in the axial direction) with respect to the sliding portions 18a and 33a. The inside region A side with respect to the sliding portions 18a and 33a has a high proportion of the flushing fluid after cooling, so that the second temperature detection part 72 can more accurately detect the second temperature. Accordingly, the cooling state of the flushing fluid at the sliding portions 18a and 33a can be more accurately grasped.

In the seal case 31, among the plurality of holes 31a that can be used as the first flow passage 31b for the flushing fluid, the hole 31a (spare hole 31c) that is not used as the first flow passage 31b is used as the insertion hole into which the second temperature detection part 72 is inserted. Accordingly, it is not necessary to form a dedicated insertion hole in the seal case 31, so that work of mounting the second temperature detection part 72 to the mounting hole 54 can be easily performed.

In the case where the temperature measurement point 71c of the first temperature detection part 71 is located within the spare hole 31c of the seal case 31, it is difficult for the flushing fluid within the spare hole 31c to circulate, and said flushing fluid tends to accumulate within the spare hole 31c, and is therefore easily affected by heat transfer from the seal case 31. In contrast, the temperature measurement point 71c of the first temperature detection part 71 of the present embodiment is located within the annular flow passage 61 formed by the adapter ring 50. Accordingly, the first temperature detection part 71 can measure the temperature of the flushing fluid circulating in the annular flow passage 61 immediately before cooling the sliding portions 18a and 33a, that is, the flushing fluid before cooling, which is less likely to be affected by heat transfer from the seal case 31. As a result, the first temperature detection part 71 can more accurately detect the first temperature, so that the cooling state of the flushing fluid at the sliding portions 18a and 33a can be more accurately grasped.

In the seal case 31, among the plurality of holes 31a that can be used as the first flow passage 31b for the flushing fluid, the hole 31a (spare hole 31c) that is not used as the first flow passage 31b is used as the insertion hole into which the first temperature detection part 71 is inserted. Accordingly, it is not necessary to form a dedicated insertion hole in the seal case 31, so that work of mounting the first temperature detection part 71 to the insertion hole (spare hole 31c) can be easily performed.

### Second Embodiment

FIG. 5 is an enlarged cross-sectional view showing a mounting hole 54 of an adapter ring 50 and an area therearound in a mechanical seal 1 according to a second embodiment of the present disclosure. In FIG. 5, the adapter ring 50 of the mechanical seal 1 of the present embodiment is different from that of the first embodiment in the configuration of the mounting hole 54 and the area therearound. The adapter ring 50 of the present embodiment has a ring body 51 and a mounting body 52. In the ring body 51, at a position corresponding to the insertion hole 31c into which the second temperature detection part 72 is inserted, a screw hole 51d is formed so as to penetrate the ring body 51 in the radial direction from the bottom surface of the second annular groove 61b.

The mounting body 52 is formed in a cylindrical shape. A male screw 52a is formed on the outer circumference of a proximal portion (lower portion in FIG. 5) of the mounting body 52. The male screw 52a of the mounting body 52 is screwed into the screw hole 51d of the ring body 51. A distal portion (upper portion in FIG. 5) of the mounting body 52 protrudes radially outward from the ring body 51, that is, into the annular flow passage 61.

Inside the mounting body 52, a mounting hole 54 and an inflow hole (inflow passage) 55 are formed in order from the radially inner side toward the radially outer side of the ring body 51. The mounting hole 54 has the same configuration as the mounting hole 54 of the first embodiment, and thus the detailed description thereof is omitted. The inflow hole 55 is formed concentrically with the mounting hole 54 on the radially outer side with respect to the mounting hole 54 and communicates with the mounting hole 54. The hole diameter of the inflow hole 55 is the same as the maximum inner diameter of the tapered inner circumferential surface 54a of the mounting hole 54. Therefore, the hole diameter of the inflow hole 55 is larger than the outer diameter of the sheath 72a of the second temperature detection part 72.

The distal end portion (lower end portion in FIG. 5) of the sheath 72a of the second temperature detection part 72 is inserted so as to penetrate the inflow hole 55 and the mounting hole 54 of the mounting body 52 from the radially outer side toward the radially inner side of the adapter ring 50. At that time, the distal end portion of the sheath 72a is guided to the fitting inner circumferential surface 54b by the tapered inner circumferential surface 54a of the mounting hole 54 and fitted to the fitting inner circumferential surface 54b.

In a state where the distal end portion of the sheath 72a is fitted to the fitting inner circumferential surface 54b of the mounting hole 54, the flushing fluid flows from the annular flow passage 61 into an annular gap S that is formed between the inner circumferential surface of the inflow hole 55 and the outer circumferential surface of the sheath 72a. In the present embodiment, a pressure loss portion 56 is formed on the outer circumference of a distal end portion of the mounting body 52 in order to inhibit the flushing fluid from flowing into the gap S.

The pressure loss portion 56 is formed so as to cause pressure loss in the flushing fluid flowing into the inflow hole 55 from the annular flow passage 61 (radially outer side of the inflow hole 55). The pressure loss portion 56 of the present embodiment is composed of a tapered outer circumferential surface 56a that is formed such that the outer diameter of the distal end portion of the mounting body 52 gradually decreases from the radially inner side toward the radially outer side of the mounting body 52. The other components of the present embodiment are the same as those of the first embodiment and thus are designated by the same reference signs, and the description thereof is omitted.

In the mechanical seal 1 of the present embodiment, the same advantageous effects as those of the first embodiment are also achieved. In addition, since the pressure loss portion 56 of the adapter ring 50 causes pressure loss in the flushing fluid flowing into the inflow hole 55, it becomes difficult for the flushing fluid to flow into the inflow hole 55. Accordingly, the flushing fluid before cooling can be inhibited from passing between the mounting hole 54 and the second temperature detection part 72 from the gap S between the inflow hole 55 and the second temperature detection part 72 and mixing with the flushing fluid after cooling within the inside region A. As a result, the second temperature detection part 72 can more accurately detect the second temperature. In addition, a seal member (a rubber stopper or the like) that inhibits the flushing fluid before cooling from passing between the mounting hole 54 and the second temperature detection part 72 is no longer required. Accordingly, troublesome work of mounting the second temperature detection part 72 to the mounting hole 54 with a seal member located therebetween is no longer required, so that work of mounting the second temperature detection part 72 to the mounting hole 54 can be easily performed.

### Others

In each embodiment described above, the temperature measurement point 71c of the first temperature detection part 71 is located within the second annular groove 61b of the annular flow passage 61, but may be located within the first annular groove 61a of the annular flow passage 61. Alternatively, the temperature measurement point 71c may be located at a position other than the annular flow passage 61 (for example, within the spare hole 31c).

In each embodiment described above, the temperature measurement point 72c of the second temperature detection part 72 is located on the inside region A side with respect to the sliding portions 18a and 33a, but may be located at any position as long as the second temperature can be detected. For example, the temperature measurement point 72c may be located on the outside region B side with respect to the sliding portions 18a and 33a. Each of the numbers of first temperature detection parts 71 and second temperature detection parts 72 is not limited to that of the present embodiment and may be two or more.

In each embodiment described above, the insertion holes into which the first temperature detection part 71 and the second temperature detection part 72 are inserted are the spare holes 31c of the seal case 31, but may be dedicated insertion holes formed in the seal case 31. The first temperature detection part 71 and the second temperature detection part 72 are not limited to sheathed thermocouples and may be temperature sensors, for example.

In each embodiment described above, the adapter ring 50 is provided separately from the seal case 31, but may be provided integrally with the seal case 31. In addition, in the second embodiment, the mounting body 52 of the adapter ring 50 is provided separately from the ring body 51, but may be provided integrally with the ring body 51. Moreover, in the second embodiment, the pressure loss portion 56 of the adapter ring 50 may have a shape other than the tapered outer circumferential surface 56a as long as pressure loss can be caused in the flushing fluid flowing into the inflow hole 55.

In each embodiment described above, the annular flow passage 61 of the second flow passage 60 is configured by the first annular groove 61a of the seal case 31 and the second annular groove 61b of the adapter ring 50, but may be configured by only one of the first annular groove 61a and the second annular groove 61b.

The mechanical seal 1 of each embodiment described above is a rotary type mechanical seal, but is not limited thereto. For example, the mechanical seal 1 may be a stationary, dual seal (tandem seal, double seal), one-coil, or bellows type mechanical seal. Alternatively, the mechanical seal 1 may be a mechanical seal in which thermosiphon occurs without actively circulating a flushing fluid, such as a double seal using a pressure tank.

The embodiments disclosed herein are merely illustrative in all aspects and should not be recognized as being restrictive. The scope of the present invention is defined by the scope of the claims rather than the meaning described above, and is intended to include meaning equivalent to the scope of the claims and all modifications within the scope.

### REFERENCE SIGNS LIST

1 mechanical seal
2 rotary side unit
3 stationary side unit
18 rotary sealing ring
18a, 33a sliding portion
31 seal case
31a hole
31b first flow passage
31c spare hole (insertion hole)
33 stationary sealing ring
50 adapter ring
54 mounting hole
54a tapered inner circumferential surface
55 inflow hole (inflow passage)
56 pressure loss portion
60 second flow passage
61 annular flow passage
71 first temperature detection part
71c temperature measurement point
72 second temperature detection part
72c temperature measurement point
90 rotary machine
91 rotary shaft
92 casing
A inside region
B outside region

1. A mechanical seal including a rotary side unit provided on a rotary shaft of a rotary machine so as to be rotatable therewith and having a rotary sealing ring, and a stationary side unit provided on a casing, of the rotary machine, surrounding the rotary shaft, the stationary side unit having a stationary sealing ring on which the rotary sealing ring slides, sliding portions of the rotary sealing ring and the stationary sealing ring being cooled by a flushing fluid, the mechanical seal comprising:
a first temperature detection part provided in the stationary side unit and configured to detect a first temperature of the flushing fluid before cooling the sliding portions; and
a second temperature detection part provided separately from the first temperature detection part in the stationary side unit and configured to detect a second temperature of the flushing fluid after cooling the sliding portions.

2. The mechanical seal according to claim 1, wherein
the stationary side unit further has
a tubular seal case for partitioning an inside region and an outside region of the rotary machine,
a first flow passage formed at a predetermined location in a circumferential direction in the seal case and configured to supply the flushing fluid before cooling the sliding portions, to the inside region, and
an adapter ring provided on the seal case in the inside region and having a second flow passage formed therein for supplying the flushing fluid from the first flow passage toward a plurality of locations in the circumferential direction of the sliding portions,
the adapter ring has a mounting hole into which the second temperature detection part is inserted from a radially outer side toward a radially inner side of the adapter ring, and
a tapered inner circumferential surface is formed at an opening end portion on the radially outer side of the mounting hole such that a hole diameter of the mounting hole gradually increases from the radially inner side toward the radially outer side.

3. The mechanical seal according to claim 2, wherein
the adapter ring further has
an inflow passage arranged on the radially outer side with respect to the mounting hole and communicating with the mounting hole, and
a pressure loss portion configured to cause pressure loss in the flushing fluid flowing into the inflow passage from the radially outer side of the inflow passage.

4. The mechanical seal according to claim 2, wherein, in a state where the second temperature detection part is inserted into the mounting hole, a temperature measurement point of the second temperature detection part is located on the inside region side with respect to the sliding portions.

5. The mechanical seal according to claim 2, wherein
a plurality of holes that can be used as the first flow passage are formed in the seal case so as to be arranged in the circumferential direction,
one of the plurality of holes is the first flow passage, and
at least another one of the plurality of holes is an insertion hole into which the second temperature detection part is inserted.

6. The mechanical seal according to claim 1, wherein
the stationary side unit further has
a tubular seal case for partitioning an inside region and an outside region of the rotary machine,
a first flow passage formed at a predetermined location in a circumferential direction in the seal case and configured to supply the flushing fluid before cooling the sliding portions, to the inside region, and
an adapter ring provided on the seal case in the inside region and having a second flow passage formed therein for supplying the flushing fluid from the first flow passage toward a plurality of locations in the circumferential direction of the sliding portions,
the second flow passage is formed on a radially outer side of the adapter ring and has an annular flow passage through which the flushing fluid flows in the circumferential direction before being supplied to the sliding portions, and
a temperature measurement point of the first temperature detection part is located within the annular flow passage.

7. The mechanical seal according to claim 6, wherein
a plurality of holes that can be used as the first flow passage are formed in the seal case so as to be arranged in the circumferential direction,
one of the plurality of holes is the first flow passage, and
at least another one of the plurality of holes is an insertion hole into which the first temperature detection part is inserted.
